(19) United States
(12) Patent Application Publication
(10) Pub. No.: US 2006/0164795 A1
(43) Pub. Date: Jul. 27, 2006

(54) Systems and methods for thermally isolating independent energy producing entities

(75) Inventors: Carl E. Jones, Tucson, AZ (US); Robert A. Kubo, Tucson, AZ (US); Gregg S. Lucas, Tucson, AZ (US)

Correspondence Address: SCULLY, SCOTT, MURPHY, & PRESSER, 400 GARDEN CITY PL, GARDEN CITY, NY, 11530, US

(73) Assignee: International Business Machines Corporation, Armonk, NY (US)

(21) Appl. No.: 11/040,869

(22) Filed: Jan. 21, 2005

(51) Int. Cl. H02B 1/00; H01M 2/02; H01M 8/24

(52) U.S. Cl. 361/600; 429/153; 429/34

(57) ABSTRACT

Systems and methods for thermally isolating multiple energy producing entities and for monitoring the operational status of each entity. A thermal dielectric placed between each of the multiple energy producing entities creates isolation or containment zones, and a monitor provided within each isolation or containment zone determines the operational status of each entity. The thermal dielectric minimizes the adverse impact a failed entity can have on neighboring entities by isolating loads generated from each individual energy producing entity. The thermal dielectric also helps isolate a monitor within one isolation or containment zone from conditions existing in a neighboring zone. Each monitor helps to identify the operational status and conditions of one of the isolation or containment zones and a corresponding one of the entities located within such zone. By minimizing the thermal interaction of loads generated by neighboring entities, each entity is less susceptible to overheating or failure due to excess thermal or other energy produced from one of the entities, and each monitor may more accurately identify the operational status of the zone and entity within which the monitor is associated. False indications of the operational data of an entity and zone are minimized as a result.

### BACKGROUND OF THE INVENTION

1. Field of the Invention

The invention generally relates to systems and methods for thermally isolating independent energy producing entities. More specifically, the invention relates to systems and methods for thermally isolating independent energy producing entities to minimize interactive failures and false failure indications between neighboring energy producing entities.

2. Related Art

Environments with multiple energy producing entities include battery back-up or portable power supply systems having multiple batteries, fuel cells, or the like. The energy produced may be radiant heat or other known energy types. Often such systems experience excessive thermal outputs produced by the failure of an individual one of the multiple energy producing entities, i.e., the batteries, fuel cells, or the like. The excessive thermal output of the failed entity can adversely impact operation of neighboring entities in close geographic proximity to the failed entity. For example, excessive thermal output from an overheated or failed individual one of the energy producing entities can thermally interact with a neighboring one of the energy producing entities, which may contribute to the overheating or failure of one or more neighboring entities. Such thermal interaction between neighboring entities can thus undesirably impact otherwise appropriately functioning neighboring entities, requiring more frequent maintenance of the multiload system and premature replacement of the energy producing entities.

The geographical positioning of multiple energy producing entities may also inadvertently contribute to miscommunication of the operational status of the multiload system. For example, thermal overheating of one of the multiple entities may be inadvertently communicated to a temperature monitoring sensor associated with an independent neighboring entity. The neighboring entity may thus be inaccurately identified as experiencing overheating or failure, whereas a different entity is actually overheating or failing. Moreover, the entity that is actually experiencing overheating or failure may not be identified appropriately once the other entity is inaccurately identified as having experienced such overheating or failure.

In view of the above, a need exists for systems and methods that can minimize operational failures of neighboring energy producing entities by thermally isolating multiple energy producing entities. A need also exists for systems and methods that can more accurately monitor the operational status of neighboring entities.

### SUMMARY OF THE INVENTION

The systems and methods of the invention provide a system having a plurality of thermally isolated energy producing entities within a housing, each entity having a thermal dielectric positioned between itself and neighboring entities. The placement of the thermal dielectric between entities effectively creates zones of isolation or containment that isolate neighboring energy producing entities from one another and substantially contain the energy created from one entity to the zone within which that entity is located. The thermal dielectric thus increases the thermal resistivity between each of the energy producing entities, and minimizes overheating or failures of neighboring entities in the event one of the multiple energy producing entities fails and produces an excessive thermal, or other energy, output.

The systems and methods of the invention further provide a monitor associated with each of the multiple energy producing entities. The monitor is located within the isolation or containment zone within which the corresponding energy producing entity is positioned. The monitors may be located on the housing wall of the system, on the dielectric material, on the energy producing entity, or some combination thereof. The monitors help to identify the temperature, or operating conditions, of the isolated containment zones and of each of the multiple energy producing entities.

According to the systems and methods of the invention, an algorithm may determine which of the entities has failed based on temperature or other data sensed from the individual monitors, the geographical location of the monitors relative to one another, and the thermal isolation properties of the thermal dielectric materials that are used to create the isolation or containment zones.

The above and other features of the invention, including various novel details of construction and combinations of parts, will now be more particularly described with reference to the accompanying drawings and claims. It will be understood that the various exemplary embodiments of the invention described herein are shown by way of illustration only and not as a limitation thereof. The principles and features of this invention may be employed in various alternative embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates perspective view of a system according to the invention.

FIG. 2 illustrates schematically a top view of the system of FIG. 1.

FIG. 3 illustrates a single energy producing entity from the system of FIG. 1.

FIG. 4 illustrates schematically another configuration of thermally isolating energy producing entities in a system according to the invention.

### DETAILED DESCRIPTION OF THE INVENTION

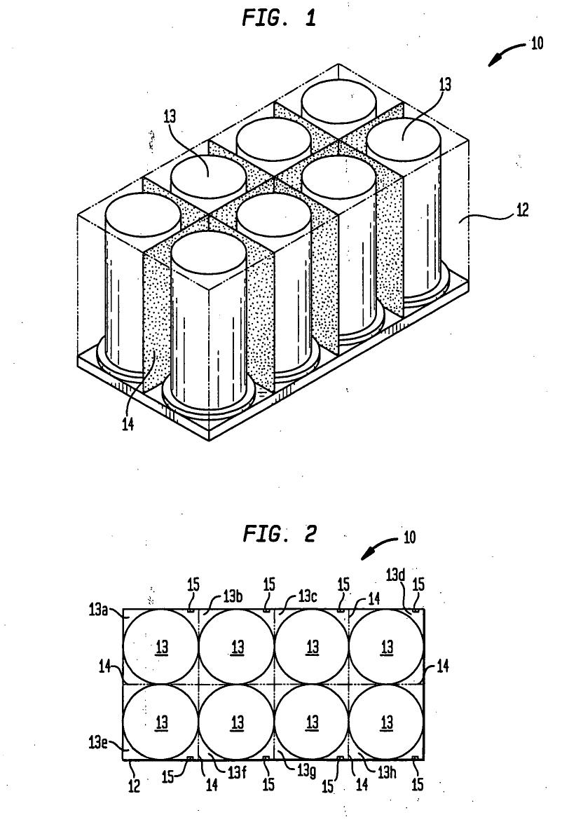

FIG. 1 illustrates a perspective view of a system according to the invention. As illustrated in FIG. 1, the system is a battery power supply system 10 comprising at least a housing 12 and a plurality of energy producing entities 13, such as batteries or fuel cells, contained therein. The artisan will appreciate that each energy producing entity 13 involves temperature changes due to internal processes occurring within each entity. The artisan will further appreciate that the energy producing entities 13 may comprise a single physical battery or fuel cell, or may comprise an aggregation of batteries or fuel cells, such as a battery pack, that are related in series, in parallel, or some combination thereof as is known in the art.

The energy produced by the energy producing entities 13 may be used to drive an individual or a multi-load system. Though the system described herein with reference to FIG. 1 is a battery power supply system 10, other systems may readily implement the systems and methods of the invention. The system of FIG. 1 should therefore be construed as illustrative only, and should not be construed or intended as limiting the systems and methods of the invention to the battery power supply system shown in FIG. 1.

FIG. 2 illustrates schematically a top view of the power supply system shown in FIG. 1. Thermal dielectric materials 14 are shown placed between each of the neighboring entities 13. The thermal dielectric materials 14 effectively create isolation or containment zones 13ₐ through 13ₕ as shown in dashed lines, for example, for each corresponding entity 13. The containment zones 13ₐ- 13ₕ substantially isolate the thermal conditions generated from a corresponding one of the entities 13 to that one of the containment zones 13a-13h the entity is located within. This minimizes the occurrence of migration of those thermal conditions to another entity or zone.

Thermal conditions often vary between entities, thus thermal conditions vary between zones in which the entities are located. In particular, the heat generated by the charge or discharge of one energy producing entity 13 can be significant and detrimental to the service life of neighboring entities. By thermally isolating each entity 13 in this manner, neighboring entities 13 are less susceptible to overheating or failure when another one of the entities 13 has generated an excessive amount of thermal energy.

Referring still to FIG. 2, a monitor 15 is placed within each containment zone 13ₐ-13ₕ, for example. One monitor 15 senses the temperature conditions of a corresponding one of the energy producing entities 13 or a corresponding one of the isolation or containment zones 13a-13h within which a corresponding one of the entities 13 is located. As shown in FIG. 2, monitor 15 may be placed along an interior surface of the housing 12 within each zone 13ₐ-13ₕ. Of course, the artisan will appreciate locating monitor 15 other than as shown in FIG. 2 is within the realm and scope of the invention. For example, the monitor 15 may instead be located on the thermal dielectric material 14, on the entity 13, on the interior of housing as shown in FIG. 2, or some combination thereof. By identifying the geographical location of the monitor 15 that is sensing an excessive thermal condition, for example, the overheated or failed entity or isolation zone containing such entity can be identified.

Referring still to FIG. 2, the energy producing entities 13, such as individual or aggregated batteries or fuel cells as known in the art, are arranged in close proximity to one another within the housing 12. The thermal dielectric material. 14, placed therebetween the various entities 13, may be comprised of materials known in the art such that the thermal isolation properties of the dielectric materials 14 are known.

Such thermal dielectric materials may include, but is not limited to, polyesters, polyimides, aramids, composites, ceramics, plastics, glass, resins, rubber, materials impregnated therewith or laminates thereof, or other such thermal dielectric materials known in the art wherein the thermal resistivity and other properties of the dielectric materials are known. The thermal dielctric material 14 is chosen for its ability to inhibit the transfer of heat from one zone to another and its ability to retain energy, for example. The dimensions of the dielectric material will vary according to the housing it is intended to be placed within, according to the properties the thermal dielectric material possesses, and according to the energy capacity of the entities the dielectric material is to isolate. Generally, the greater the thermal resistivity property of the dielectric material, the less dielectric material is needed between neighboring entities. Likewise, the greater the energy producing capacity of an entity, the greater the thermal resistivity property of the dielectric material should be in order to sufficiently suppress interactive failures between neighboring entities.

For example, in a system such as shown in FIG. 1, wherein one entity 13 is situated in a corresponding one of the isolation or containment zones 13a-13h created by the placement of the dielectric materials 14 between the entities 13, and presuming each entity is capable of generating a 5 degree Celsius temperature rise over a period of 100 seconds, which would equate to a thermal flux of approximately 3000 W/m³, the dielectric material 14 would preferably have known properties including thermal conductivity of 0.03 W/mK, a thermal diffusivity of 3E-9m²/s, and a volumetric heat density of about 10E5 J/K.m³. These characteristics support a temperature gradient of 6 degrees C. across a 2 mm thick dielectric 14, for example. In this manner, the heat or energy produced by any one of the entities 13 is less likely to migrate into adjacent or neighboring isolation or containment zones to cause detrimental interactive impact on neighboring entities 13.

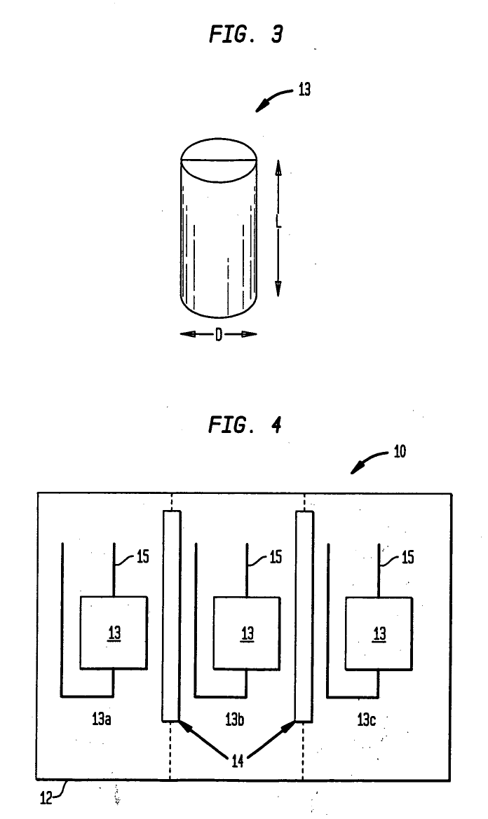

FIG. 3 illustrates in greater detail an exemplary one of the energy producing entities 13 of the battery power supply system of FIG. 1 and FIG. 2. As shown in FIG. 3, each entity 13 has a generally cylindrical shape composed of a length L and a width D. Of course, the artisan will appreciate that although cylindrically shaped entities are common in the art, practice of the invention is not limited to such cylindrically shaped entities. Rather, entities having shapes other than the cylindrical shape shown in FIG. 3 are readily contemplated and usable within the context and scope of the systems and methods of the invention.

FIG. 4 illustrates schematically another configuration for isolating energy producing entities according to the invention, wherein like numerals are used to indicate like features. As shown in FIG. 4, a plurality of energy producing entities 13 are arranged within a housing 12. A thermal dielectric material placed between each of the entities 13 effectively creates isolation or containment zones 13ₐ-13_{c}. Because only three energy producing entities 13 are shown in FIG. 4, only three zones 13ₐ-13_{c} are created. A monitor 15, comprised of a temperature sensor, for example, is associated with a corresponding one of the entities 13. The artisan should readily appreciate that a variety of configurations for thermally isolating neighboring energy producing entities using thermal dielectric materials according to the invention are available, in addition to those configurations shown in FIG. 1, FIG. 2 and FIG. 4. Likewise, as discussed above with respect to FIG. 2, the monitor 15 may be differently located, within each respective zone 13a-13c, than as shown in FIG. 4.

The geographic location of each energy producing entity 13 relative to its neighboring entities, the geographic location of the monitors 15 within a respective one of the isolation or containment zones 13ₐ-13ₕ, for example, and the known properties of the dielectric materials 14 placed between the entities 13 contribute to monitoring the operating conditions of the respective zones 13ₐ-13ₕ and entities 13. For example, given the real-time temperature data of all neighboring entities, the geographic position of each monitor, and the thermal isolation properties of the thermal dielectric material, an algorithm can be used to identify which entity, if any, is experiencing overheating or failure.

Likewise, using the same real time temperature data, geographic position of each monitor, and thermal isolation properties of the thermal dielectric materials, the algorithm can also help minimize the occurrence of false reads of entities unaffected by the overheating or failure of a neighboring entity. In other words, the algorithm can help minimize the inaccurate identification of a functioning entity as overheating or failing merely because of its proximity to an actually overheating or failing neighboring entity. The temperature data, geographic positioning and isolation property information could be input to a computer (not shown), for example, as known in the art, to perform the algorithm functions and display its results.

The various exemplary embodiments of the invention as described hereinabove do not limit different embodiments of the present invention. The material described herein is not limited to the materials, designs, or shapes referenced herein for illustrative purposes only, and may comprise various other materials, designs or shapes suitable for the systems and procedures described herein as should be appreciated by one of ordinary skill in the art.

While there has been shown and described what is considered to be preferred embodiments of the invention, it will, of course, be understood that various modifications and changes in form or detail could readily be made without departing from the spirit or scope of the invention. It is therefore intended that the invention be not limited to the exact forms described and illustrated herein, but should be construed to cover all modifications that may fall within the scope of the appended claims.

What is claimed is:

1. A system for thermally isolating energy producing entities, the system comprising:
a housing;
a plurality of energy producing entities arranged within the housing; and
a dielectric material between each of the energy producing elements.

2. The system of claim 1, wherein the dielectric material further creates, an isolation zone for each entity within the housing.

3. The system of claim 1, wherein the dielectric material minimizes interactive failure between neighboring entities.

4. The system of claim 2, wherein the dielectric material inhibits heat transfer between zones.

5. The system of claim 1, wherein the system comprises less dielectric material as thermal resistivity of the thermal dielectric material increases.

6. The system of claim 2, further comprising:
a monitor associated with each isolation zone for sensing at least one condition of a respective one of the isolation zones and a corresponding one of the plurality of energy producing entities.

7. The system of claim 6, wherein the at least one condition is temperature.

8. The system of claim 6, wherein each monitor is located on an internal surface of the housing within a respective one of the isolation zones.

9. The system of claim 6, wherein each monitor is located on the dielectric material within a respective one of the isolation zones.

10. The system of claim 6, wherein each monitor is located on a corresponding one of the entities within a respective one of the isolation zones.

11. The system of claim 6, wherein the operating conditions of the isolation zones and the respective entities corresponding therewith are identified based on geographic positions of the respective entities and monitors, properties of the dielectric materials, and the sensed conditions of the isolation zones and respective entities corresponding therewith.

12. The system of claim 1, wherein the plurality of energy producing entities is comprised of individual batteries, an aggregation of batteries, individual fuel cells, or an aggregation of fuel cells.

13. The system of claim 12, wherein the plurality of energy producing entities are connected in parallel, in series, or a combination thereof.

14. The system of claim 1, wherein the dielectric material is comprised of a material from among polyesters, polyimides, aramids, composites, ceramics, plastics, glass, resins, rubber, and materials impregnated therewith or laminates thereof.

15. A method for thermally isolating independent energy producing entities, the method comprising:
providing a housing with a plurality of independent energy producing entities contained therein;
placing a dielectric material of known properties between neighboring entities and forming isolation zones thereby, each isolation zone corresponding to a respective energy producing entity situated therein;
providing a monitor within each isolation zone;
determining conditions of the respective isolation zones and entities contained therein; and
identifying the failed isolation zone and respective entity if the sensed operating conditions are beyond the acceptable range.

16. The method of claim 14, wherein the sensed conditions are temperature conditions.

17. The method of claim 15, wherein determining the conditions of the respective isolation zones and entities contained therein comprises obtaining sensed data from the respective monitors, inputting known geographic locations of the monitors, known properties of the dielectric materials, and the sensed data to a computer having an algorithm provided therewith for identifying failed entities based on the results of the algorithm.

18. The method of claim 17, further comprising displaying the results.

19. The method of claim 17, further comprising minimizing the thermal interaction of loads generated by adjacent entities

20. The method of claim 18, further comprising minimizing false reads of functioning entities as failed entities due to the minimized thermal interaction of adjacent entities.
